(19) United States
(12) Patent Application Publication
(10) Pub. No.: US 2006/0175857 A1
(43) Pub. Date: Aug. 10, 2006

(54) Vehicle door protection system

(76) Inventor: Donald J. Blazavier, Kenosha, WI (US)

Correspondence Address: Lesavich High-Tech Law Group, P.C.;Suite 325, 39 S. LaSalle Street, Chicago, IL, 60603, US

(21) Appl. No.: 11/349,453

(22) Filed: Feb. 7, 2006

Related U.S. Application Data
(60) Provisional application No. 60/650,732, filed on Feb. 7, 2005.

(51) Int. Cl. B62D 25/00

(52) U.S. Cl. 296/55

(57) ABSTRACT

A vehicle door protection system. The system includes a safety stop for vehicle doors that prevents the vehicle doors from opening more than a desired opening distance. The system allows a vehicle door opening to be adjusted to the preferences of a vehicle owner and prevents the vehicle door from opening too far, and also allowing the vehicle door to be closed easier.

### CROSS REFERNCES TO RELATED APPLICATIONS

This application claims priority to U.S. Provisional Application 60/650,732, filed Feb. 7, 2005, the contents of which are incorporated by reference.

### FIELD OF THE INVENTION

This invention relates to vehicles such as pick-up trucks with a vehicle cap covering the opening or any vehicles with large heavy cargo doors. More specifically, it relates to a vehicle door protection system.

### BACKGROUND OF THE INVENTION

Owners of pick-up trucks and other similar vehicles often cover the bed of the pick-up with a vehicle cap. The vehicle cap typically has one or more doors to allow entry into a bed of the pick-up. There are several problems associated with such vehicle cap doors.

One problem is that such vehicle cap door can be caught by the wind upon opening over extending the door and causing damage to the door and/or the opening mechanism. Such damage typically results in expenses in the amount of $275 to $450 or more in repairs.

Another problem is that such vehicle cap doors are often over extended by a vehicle owner, or children of the vehicle owner also causing damage to the door and/or the opening mechanism.

Another problem is that such vehicle cap doors are often open too high for shorter people and children to grab and re-close and may be too heavy for some adults and most children to grab and pull down from a “normal” open position.

Vehicle doors on SUVs and other multi-passenger vehicles such as station wagons and passenger vehicles with hatchback or other cargo doors also suffer from the same problems.

Thus, it is desirable to provide a method and system for protecting vehicle doors, such as vehicle cap doors.

### SUMMARY OF THE INVENTION

In accordance with preferred embodiments of the present invention, some of the problems associated with vehicle doors are overcome. A vehicle door protection system is presented.

The invention includes a safety stop for vehicle doors. The vehicle safety stop is adjustable by a vehicle owner and prevents a vehicle door from opening too far, and also allows the vehicle door to be closed easier by vehicle owners and children who are short in height or have limited strength and in windy weather.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram of an exemplary vehicle cap;

FIG. 2 is a block diagram illustrating plural embodiments of vehicle door safety stops; and

FIG. 3 is a flow diagram illustrating a method for securing a vehicle door with a vehicle door safety stop.

### DETAILED DESCRIPTION OF THE INVENTION

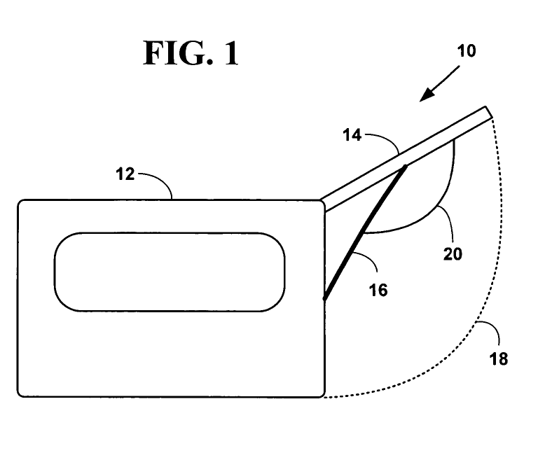

FIG. 1 is a block diagram of an exemplary vehicle portion 10. The vehicle portion 10 includes a vehicle body 12, a vehicle door 14, a vehicle door opening mechanism 16, a vehicle door opening span 18, and a vehicle door safety stop 20.

However, the present invention is not limited to this embodiment and the vehicle portion 10 can include more, fewer or other components. In one embodiment, the vehicle portion 10 includes a vehicle cap such as those used on pick-up trucks. In another embodiment, the vehicle portion 10 includes an attached or integral component of a vehicle such as an attached door of an SUV, station wagon, other automobile, hybrid vehicle, etc.

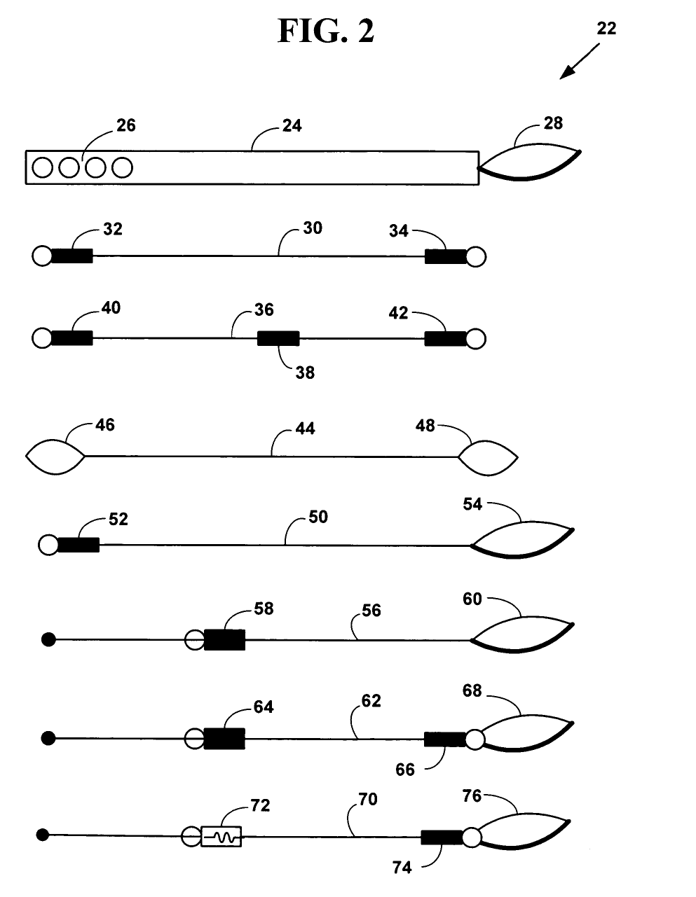

FIG. 2 is a block diagram illustrating plural embodiments 22 of a vehicle door safety stop 20. The vehicle door safety stop 20 includes an attachment portion of a pre-determined length and adjustment portion. The vehicle door safety stop 20 allows a vehicle door opening 18 span to be adjusted based on preferences of a vehicle owner using the adjustment portion to adjust a length of the attachment portion. The attachment portion prevents the vehicle door 14 from opening too far, and also allows the vehicle door 14 to be closed easier. The vehicle door safety stop 20 protects a vehicle door 14 in windy conditions and aids shorter vehicle owners and adults and children with limited strength from struggling with a heavy vehicle door 14.

In one embodiment, the attachment portion includes a length of about eighteen inches to about twenty-four includes. This length is chosen because a vehicle owner typically likes to adjust a vehicle door opening span 18 to a distance of about fifteen inches to about eighteen inches. If the attachment portion is too long, large adjustment must be made by the adjustment portion and can cause problems since there is too much extra unused material left on the attachment portion. However, the present invention is not limited to such an embodiment and other lengths can also be used for the attachment portion to practice the invention.

A first embodiment includes an attachment portion comprising a strap 24 with plural holes 26 and an adjustment portion comprising a snap clip 28. The length of the strap 24 is adjusted by snapping the snap clip 28 into one of the holes 26 in the strap 24.

Another embodiment includes length of cable 30 of a pre-determined length with a first permanently attached eyelet 32 at a first end and a removable second eyelet 34 at a second end. The length of the cable 30 is adjusted by removing removable second eyelet 34, cutting the cable to create a desired length and re-attaching the second eyelet 34 to the cable.

Another embodiment includes a cable 36 of a pre-determined length wherein a portion of the cable 30 is storable in a pressed sleeve 38. The cable 36 includes a first eyelet 40 at a first end and second eyelet 42 at a second end of the cable 36. The length of the cable 36 is adjusted by the adding or removing a portion of the cable 36 to or from the pressed sleeve 38.

Another embodiment includes a cable 44 of a pre-determined length with a first loop 46 at a first end and a second loop 48 at a second end. The length of the cable is adjusted by looping a portion of the cable 44 through the second loop 48 one or more times to achieve a desired length.

Another embodiment includes a length of cable 50 of a pre-determined length with a first eyelet 52 on a first end and a snap clip 54 on a second end. The length of the cable is adjusted by looping a portion of the cable 50 through the snap clip 54 one or more times to achieved a desired length.

Another embodiment includes a cable 56 of a pre-determined length with a sliding eyelet 58 slideable between a first end and a snap clip 60 at a second end of the cable 56. A portion of the cable 56 is storable in the sliding eyelet 58. The cable 56 includes a stop on the end of the first end of the cable to prevent the sliding eyelet 58 from sliding off the first end of the cable 56. The length of the cable 56 is adjusted by sliding the sliding eyelet 58 along the cable 56 to a desired position on the cable 56, thereby storing a portion of the cable 56 in the sliding eyelet 58 and shortening the length of the cable. In another embodiment, a portion of the cable 56 is not stored in the sliding eyelet 58. Instead, sliding the sliding eyelet 58 creates a loop in the cable 56 that shortens its length.

Another embodiment includes a cable 62 of a pre-determined length with a sliding eyelet 64 slideable between a first end and a fixed eyelet 66 at a second end and a snap clip 68 attached to the fixed eyelet 66 at the second end. A portion of the cable 62 is storable in the sliding eyelet 64. The cable 62 includes a stop on the end of the first end to prevent the sliding eyelet 66 from sliding off the first end. The length of the cable 62 is adjusted by sliding the sliding eyelet 64 along the cable 62 to a desired position on the cable 62, thereby creating a loop in the cable and shortening the length of the cable 62.

In another embodiment, the length of the cable 62 is adjusted by sliding the sliding eyelet 64 along the cable 62 to a desired position on the cable 62, thereby storing a portion of the cable 62 in the sliding eyelet 64 and shortening the length of the cable.

Another embodiment includes a cable 70 of a pre-determined length with a spring-tension sliding eyelet 72 slideable between a first end and a fixed eyelet 74 at a second end and a snap clip 76 attached to the fixed eyelet 76 at the second end. The spring-tension sliding eyelet 72 is moved by compressing the spring, moving the eyelet and then releasing the spring. The spring-tension sliding eyelet 72 retains a desired position based on spring tension and be easily and quickly moved by compressing and un-compressing the spring. The cable 70 includes a stop on the end of the first end to prevent the sliding eyelet 72 from sliding off the first end. The length of the cable 70 is adjusted by sliding the spring tension sliding eyelet 72 along the cable 70 to a desired position on the cable 70, thereby creating a loop in the cable and shortening the length of the cable 70. In another embodiment, the length of the cable 70 is adjusted by sliding the spring tension sliding eyelet 72 along the cable 70 to a desired position on the cable 70, thereby storing a portion of the cable 70 in the sliding eyelet 72 and shortening the length of the cable. However, the present invention is not limited to these embodiments and other embodiments, other components and other combination of components can also be used to practice the invention.

In one embodiment, the strap 24 is a cloth, fiberglass, composite or other types of materials. In one embodiment, the cables 30, 36, 44, 50, 56 52 and 70 include a metallic or composite material wire-rope with plural strands, a single strand of metal cable (e.g., 1/16″ cable), single or plural strands of composite materials or other types of materials.

In one embodiment, the spring clips 28, 54, 50, 68 and 76 are metal, plastic, composite materials, or other types of materials.

In one embodiment a single vehicle door safety stop 20 is used on a selected side of a vehicle door 14. In another embodiment, two vehicle door safety stops 20 are used on two selected sides of a vehicle door 14. However, the present invention is not limited to these embodiments and more than two vehicle door safety stops 20 can be used to practice the invention.

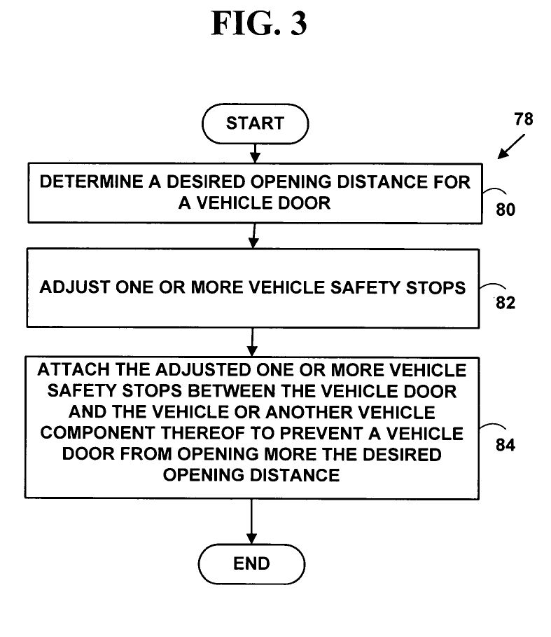

FIG. 3 is a flow diagram illustrating a Method 78 for securing a vehicle door 14 with a vehicle door safety stop 20. At Step 80, a desired opening distance for a vehicle door 14 is determined. At Step 82, one or more vehicle door safety stops 20 are adjusted. At Step 84, the one more adjusted vehicle safety stops 20 are attached between a vehicle door 14 and a vehicle body 12 or a vehicle door opening mechanism 16 or another vehicle component thereof to prevent a vehicle door from opening more than the determined desired distance.

Method 78 is illustrated with one exemplary embodiment. However, the present invention is not limited to this embodiment and other embodiments can also be used to practice the invention.

In such an exemplary embodiment at Step 80, a desired opening distance for a vehicle door 14 is determined. In a typical embodiment, the desired opening distance would be no more than about fifteen inches to about eighteen inches, depending on the height of the vehicle and the height and width of the vehicle door 14. This opening is typically enough for normal everyday use of the vehicle door 14. However, the plural embodiments 22 of the vehicle door safety stops 20 are adjustable and can be adjusted to allow for personal preferences of a vehicle owner including a vehicle owner's height and strength.

At Step 82, one or more vehicle door safety stops 20 are adjusted. For example, in embodiment 24 the plural holes 26 are used. In embodiment 62, the first slideable eyelet 64 is used, etc.

At Step 84, the one more adjusted vehicle safety stops 20 are attached between the vehicle door 14 and the vehicle body 12 or the vehicle door opening mechanism 16 or another vehicle component thereof to prevent a vehicle door from opening more than the desired distance.

In one embodiment, one or more of the plural embodiments 22 of the vehicle door safety stops 20 illustrated in FIG. 2 are mounted at a first end to a vehicle door opening mechanism 16 and at a second end to a vehicle body 12. The vehicle door safety stop 20 secures a vehicle door 14 from opening more than the desired opening distance.

In another embodiment, one or more of the plural embodiments 22 of the vehicle door safety stops 20 illustrated in FIG. 2 are mounted between the vehicle body 12 and the vehicle door 14.

In another embodiment, one or more of the plural embodiments 22 of the vehicle door safety stops 20 illustrated in FIG. 2 are mounted between the vehicle door 14 and another component of the vehicle body 12.

However, the present invention is not limited to these embodiments and other embodiments can also be used to practice the invention.

In one embodiment one vehicle door safety stop 20 is used. In another embodiment, a two vehicle door safety stops 20, one on each end of the vehicle door 14.

However, the present invention is not limited to these embodiment and more vehicle door safety stops 20 can also be used to practice the invention.

The plural embodiments 22 of the vehicle door safety stop 20 are all adjustable to fit virtually on any vehicle including, cars, trucks, SUVs, etc. The plural embodiments 22 of the vehicle door safety stop 20 are easily removable allowing the vehicle door 14 to be raised up to its original open height for loading tall and bulky items.

The plural embodiments 22 of the vehicle door safety stop 20 are also easily re-attachable after they are removed. The vehicle door safety stops 20 also aid shorter vehicle owners, vehicle owners with limited, strength and children. The vehicle door safety stops 20 also aid vehicle owners in bad weather such as strong winds, etc.

The method and system described herein was described with respect to vehicle caps. However the present invention is not limited to vehicle caps and can also be used on SUVs and other multi-passenger vehicles such as station wagons and passenger vehicles with hatchback or other type of vehicle doors or cargo doors.

It should be understood that the specific components and apparatus described herein are not related or limited to any particular type apparatus unless indicated otherwise. Various types of general purpose or specialized apparatus may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the apparatus described may include more or fewer elements.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

I claim:

1. A vehicle door safety stop, comprising in combination:
an attachment portion of a pre-determined length; and
an adjustment portion, wherein the vehicle door safety stop allows a vehicle door opening to be adjusted based on preferences of a vehicle owner using the adjustment portion to adjust a length of the attachment portion and wherein the attachment portion prevents the vehicle door from opening too far, and also allows the vehicle door to be closed easier.

2. The vehicle door safety stop of claim 1 wherein the attachment portion includes a strap with a plurality of openings at one end and the adjustment portion includes a snap clip at another end of the strap and wherein the length of the strap is adjusted by selecting a hole from the plurality of holes and snapping the snap clip into the selected hole.

3. The vehicle door safety stop of claim 1 wherein the attachment portion includes a cable of pre-determined length with a first permanently attached eyelet at a first end of the cable and a removable second eyelet at a second end of the cable, wherein the length of the cable is adjusted by removing the removable second eyelet, cutting the cable to a desired length and replacing the removable second eyelet on the cable.

4. The vehicle door safety stop of claim 1 wherein the attachment portion includes a cable of a pre-determined length and an adjustment portion comprising a pressed sleeve, wherein a portion of the cable is storable in the pressed sleeve, wherein the cable includes a first eyelet at a first end and second eyelet at a second end of the cable and wherein the length of the cable is adjusted by the inserting or removing a desired portion of the cable in the pressed sleeve.

5. The vehicle door safety stop of claim 1 wherein the attachment portion includes a cable of a pre-determined length with a first loop at a first end and an attachment portion including a second loop at a second end of the cable wherein the length of the cable is adjusted by looping a portion of the cable through the second loop one or more times to achieved a desired length.

6. The vehicle door safety stop of claim 1 wherein the attachment portion includes a cable of a pre-determined length with a first eyelet on a first end and an attachment portion including snap clip on a second end of the cable wherein the length of the cable is adjusted by looping a portion of the cable through the snap clip one or more times to achieved a desired length.

7. The vehicle door safety stop of claim 1 wherein the attachment portion includes a cable of a pre-determined length and an attachment portion including a sliding eyelet slideable between a first end of the cable and a snap clip at a second end of the cable, wherein the cable includes a stop on the end of the first end to prevent the sliding eyelet from sliding off the first end of the cable, wherein a portion of the cable is storable in the sliding eyelet and wherein the length of the cable is adjusted by sliding the slideable eyelet along the cable to a desired position, thereby creating a loop in the cable and shortening the length of the cable or by sliding the sliding eyelet along the cable to a desired position, thereby storing a portion of the cable in the sliding eyelet and shortening the length of the cable.

8. The vehicle door safety stop of claim 1 wherein the attachment portion includes a cable of a pre-determined length and an attachment portion including a sliding eyelet slideable between a first end and a snap clip attached to a fixed eyelet at a second end of the cable, wherein the cable includes a stop on the first end to prevent the sliding eyelet from sliding off the first end of the cable, wherein the sliding eyelet stores a portion of the cable and wherein the length of the cable is adjusted by sliding the slideable eyelet along the cable to a desired position, thereby creating a loop in the cable and shortening the length of the cable or by sliding the sliding eyelet along the cable to a desired position, thereby storing a portion of the cable in the sliding eyelet and shortening the length of the cable.

9. The vehicle door safety stop of claim 1 wherein the attachment portion includes a cable of a pre-determined length and the attachment portion includes a spring- tension sliding eyelet slideable between a stop at a first end of the cable and a fixed eyelet at a second end of the cable, the fixed eyelet including a snap clip attached to the fixed eyelet at the second end of the cable, wherein the spring tension sliding eyelet stores a portion of the cable and wherein the length of the cable is adjusted by sliding the slideable eyelet along the cable to a desired position, thereby creating a loop in the cable and shortening the length of the cable or by sliding the spring tension sliding eyelet along the cable to a desired position, thereby storing a portion of the cable in the spring tension sliding eyelet and shortening the length of the cable.

10. A method for securing a vehicle door with a vehicle door safety stop, comprising:
determining a desired opening distance for a vehicle door based on vehicle owner preferences;
adjusting one or more vehicle door safety stops based on the determined desired opening distance; and
attaching the one more adjusted vehicle safety stops between the vehicle door and a vehicle body or a vehicle door opening mechanism or another vehicle component thereof to prevent a vehicle door from opening more than the determined desired distance.

11. The method of claim 10 wherein the one or more vehicle safety stops comprise an attachment portion of a pre-determined length; and an adjustment portion, wherein the one or more vehicle door safety stop allow a vehicle door opening to be adjusted based on preferences of a vehicle owner using the adjustment portion to adjust a length of the attachment portion and wherein the attachment portion prevents the vehicle door from opening too far, and also allows the vehicle door to be closed easier.

12. The method of claim 10 further comprising:
detaching the one more vehicle safety stops from the vehicle door;
opening the vehicle door to its maximum position;
loading an item into the vehicle via the vehicle door; and
reattaching the one or more vehicle safety stops between the vehicle door and a vehicle body or a vehicle door opening mechanism or another vehicle component thereof to prevent a vehicle door from opening more than the determined desired distance.

13. A vehicle door safety stop, comprising in combination:
an attachment means of a pre-determined length; and
an adjustment means, wherein the vehicle door safety stop allows a vehicle door opening to be adjusted based on preferences of a vehicle owner using the adjustment means to adjust a length of the attachment means and wherein the attachment means prevents the vehicle door from opening too far, and also allows the vehicle door to be closed easier.

14. The vehicle door safety stop of claim 13 wherein the attachment means includes a strap or a cable.

15. The vehicle door safety stop of claim 13 wherein the cable includes a metallic or composite material cable.

16. The vehicle door safety stop of claim 15 wherein the metallic cable or composite material cables include single strand or multiple strand cables.

17. The The vehicle door safety stop of claim 13 wherein the adjustment means includes spring clips, eyelets, pressed sleeves, slideable eyelets, loops, or spring tension slideable eyelets.
